(19) United States
(12) Patent Application Publication
(10) Pub. No.: US 2024/0426541 A1
(43) Pub. Date: Dec. 26, 2024

(54) EVAPORATOR PAN WITH CONTROL SYSTEM

(71) Applicant: Zoppas Industries de Mexico S.A., de C.V., San Luis Potosi (MX)

(72) Inventors: Evodio Escandon MENDEZ, San Luis Potosi (MX); Luis Manuel ROJAS TORRES, San Luis Potosi (MX); Maurizio PASCUAL, San Luis Potosi (MX); Joaquin Rodriguez MENDOZA, San Luis Potosi (MX); Mauro BERIOLI, Fregona (IT); Gianluca CESTARO, Mira (IT); Antonio DE MOLINER, Oderzo (IT); Michele Raffaele LA TORRE, Monte Sant Angelo (IT)

(21) Appl. No.: 18/750,153

(22) Filed: Jun. 21, 2024

Related U.S. Application Data
(60) Provisional application No. 63/509,728, filed on Jun. 22, 2023.

(51) Int. Cl. F25D 21/14; H05B 1/02

(52) U.S. Cl. CPC F25D 21/14; H05B 1/02; F25D 2321/1413

(57) ABSTRACT

An evaporator pan system includes an evaporator pan, a heating element positioned at least partially within the evaporator pan, a thermistor positioned at least partially within the evaporator pan, and a controller coupled to the heating element and the thermistor. The controller detects a first current passing through the thermistor. The controller further determines the first current meets a threshold current, indicating a presence of a threshold volume of liquid within the evaporator pan. The controller further activates the heating element to cause evaporation of at least a portion of the liquid within the evaporator pan.

### CROSS-REFERENCE

This application claims the benefit of priority to U.S. Provisional Application No. 63/509,728, filed Jun. 22, 2023, which is hereby incorporated by reference in its entirety and for all purposes.

### FIELD

The subject matter described herein generally relates to evaporator drip pans and more specifically relates to evaporator pans including a control system.

### BACKGROUND

Drip pans may be used to collect liquid from cooling systems, such as refrigerators. This helps to prevent leakage of the liquid. To prevent overflow of the liquid collected by the drip pans, a mechanical switch or float may be used. The mechanical switch or float may indicate a liquid level within the drip pan, and the liquid may be drained or otherwise removed from the drip pan depending on the liquid level. However, such mechanical switches or floats may contain a significant number of moving parts that can lead to mechanical failure or inaccurate liquid level determinations.

### SUMMARY

Systems and methods for evaporator pans with control systems are disclosed. Implementations consistent with the current subject matter particularly relate to an evaporation tray provided with an electric heater adapted to evaporate the condensation water produced, for example, in refrigerators, boilers, heat pumps, etc., and to a method for controlling the operation of the evaporation tray.

In one aspect, there is provided an evaporator pan system. The evaporator pan system includes an evaporator pan, a heating element, a thermistor, and a controller. The heating element may be at least partially positioned within the evaporator pan. The heating element is configured to heat a liquid within the evaporator pan to cause evaporation of the liquid. The thermistor may be positioned at least partially within the evaporator pan. The controller may be coupled to the heating element and the thermistor. The controller includes at least one data processor and at least one memory storing instructions, which when executed by the at least one data processor, are configured to cause operation. The operations may include detecting a first current passing through the thermistor. The operations may further include determining the first current meets a threshold current. The first current meeting the threshold current indicates a presence of a threshold volume of the liquid within the evaporator pan. The operations may also include activating, based on determining the first current is greater than the threshold current, the heating element to cause evaporation of at least a portion of the liquid within the evaporator pan.

In some variations, one or more of the features disclosed herein including the following features can optionally be included in any feasible combination.

In some variations, the thermistor is a positive temperature coefficient (PTC) heater.

In some variations, the first current corresponds to a decreased temperature experienced by the thermistor. The decreased temperature may be associated with a volume of the liquid within the evaporator pan meeting the threshold volume. At least the portion of the liquid may be in contact with the thermistor when the volume of the liquid within the evaporator pan meets the threshold volume of the liquid.

In some variations, the operations further include: supplying power to the heating element until a second current is detected that is lower than the threshold current.

In some variations, the operations further include detecting the second current passing through the thermistor and determining, based on the detected second current, the second current fails to meet the threshold current. The second current failing to meet the threshold current indicates a volume of the liquid is less than the threshold volume of the liquid.

In some variations, the operations further include: reducing power to the heating element or preventing power from being supplied to the heating element based on determining the second current fails to meet the threshold current.

In some variations, a decrease from the first current to the second current corresponds to an increase in temperature experienced by the thermistor. The increase in temperature raises a resistance of the thermistor. The increase in temperature indicates the volume of the liquid is less than the threshold volume of the liquid.

In some variations, the operations further include: continuously supplying power to the thermistor.

In some variations, the operations further include: generating an alert based on determining the first current meets a threshold current.

In some variations, the heating element is configured to heat at least a portion of the liquid in contact with the heating element.

In some variations, the heating element is coupled to the thermistor.

In some variations, the thermistor includes the heating element.

In some variations, the thermistor and the heating element are positioned within a tube.

In some variations, the heating element surrounds at least a portion of the thermistor.

In some variations, the controller is mounted to the evaporator pan.

In some variations, the heating element includes a resistive heating wire.

In some variations, at least a portion of the heating element is parallel to a base of the evaporator pan.

In some variations, at least the portion of the heating element is spaced apart from the base of the evaporator pan, allowing at least some of the liquid to be positioned between the base and the heating element without contacting the heating element. The spacing between the base of the evaporator pan and at least the portion of the heating element corresponds to the threshold volume of the liquid.

In some variations, the liquid is at least one of water and condensation.

In some variations, the evaporator pan includes at least one of aluminum, stainless steel, plastic.

In some variations, the system includes at least one of a refrigerator, a boiler, an immersion heater, and a heat pump.

In one aspect, a computer-implemented method include detecting, by a controller, a first current passing through a thermistor of an evaporator pan control system coupled to an evaporator pan. The evaporator pan control system may include: a heating element at least partially positioned within the evaporator pan. The heating element may be configured to heat a liquid within the evaporator pan to cause evaporation of the liquid. The thermistor may be positioned at least partially within the evaporator pan. The control system may further include the controller, which may be coupled to the heating element and the thermistor. The method may also include determining, by the controller, the first current meets a threshold current. The first current meeting the threshold current may indicate a presence of a threshold volume of the liquid within the evaporator pan. The method may also include activating, by the controller and based on determining the first current is greater than the threshold current, the heating element to cause evaporation of at least a portion of the liquid within the evaporator pan.

In some variations, the thermistor is a positive temperature coefficient (PTC) heater.

In some variations, the first current corresponds to a decreased temperature experienced by the thermistor. The decreased temperature may be associated with a volume of the liquid within the evaporator pan meeting the threshold volume. At least the portion of the liquid is in contact with the thermistor when the volume of the liquid within the evaporator pan meets the threshold volume of the liquid.

In some variations, the method also includes supplying power to the heating element until a second current is detected that is lower than the threshold current.

In some variations, the method also includes detecting the second current passing through the thermistor and determining, based on the detected second current, the second current fails to meet the threshold current. The second current failing to meet the threshold current indicates a volume of the liquid is less than the threshold volume of the liquid.

In some variations, the method also includes reducing power to the heating element or preventing power from being supplied to the heating element based on determining the second current fails to meet the threshold current.

In some variations, a decrease from the first current to the second current corresponds to an increase in temperature experienced by the thermistor. The increase in temperature raises a resistance of the thermistor. The increase in temperature indicates the volume of the liquid is less than the threshold volume of the liquid.

In some variations, the method also includes continuously supplying power to the thermistor.

In some variations, the method also includes generating an alert based on determining the first current meets a threshold current.

In some variations, the heating element is configured to heat at least a portion of the liquid in contact with the heating element.

In some variations, the heating element is coupled to the thermistor.

In some variations, the thermistor includes the heating element.

In some variations, the thermistor and the heating element are positioned within a tube.

In some variations, the heating element surrounds at least a portion of the thermistor.

In some variations, the controller is mounted to the evaporator pan.

In some variations, the heating element includes a resistive heating wire.

In some variations, at least a portion of the heating element is parallel to a base of the evaporator pan.

In some variations, at least the portion of the heating element is spaced apart from the base of the evaporator pan, allowing at least some of the liquid to be positioned between the base and the heating element without contacting the heating element. The spacing between the base of the evaporator pan and at least the portion of the heating element corresponds to the threshold volume of the liquid.

In some variations, the liquid is at least one of water and condensation.

In some variations, the evaporator pan includes at least one of aluminum, stainless steel, plastic.

In one aspect, a non-transitory computer-readable medium storing instructions, which when executed by at least one data processor, result in operation. The operations include detecting, by a controller, a first current passing through a thermistor of an evaporator pan control system coupled to an evaporator pan. The evaporator pan control system includes: a heating element at least partially positioned within the evaporator pan, and a controller. The heating element may be configured to heat a liquid within the evaporator pan to cause evaporation of the liquid. The thermistor may be positioned at least partially within the evaporator pan. The controller is coupled to the heating element and the thermistor. The operations also include determining, by the controller, the first current meets a threshold current. The first current meeting the threshold current indicates a presence of a threshold volume of the liquid within the evaporator pan. The operations also include activating, by the controller and based on determining the first current is greater than the threshold current, the heating element to cause evaporation of at least a portion of the liquid within the evaporator pan.

In one aspect, an evaporation tray for condensation water, in particular for a refrigerator, includes an electric heater adapted to generate heat when it is electrically powered, arranged so as to heat the water contained in the tray, in particular to evaporate it, a PTC cartridge adapted to be electrically powered, arranged inside the tray so as to be wetted by the water contained in the tray, adapted to operate as a sensor for the presence of water in the tray, and an electronic control unit connected to the electric heater and to the PTC cartridge, configured to control, in particular to allow or prevent, the electric power supply of the electric heater.

In some variations, the electronic control unit is configured to allow or prevent the electric power supply of the electric heater as a function of the electric power absorbed by the PTC cartridge or of the electric current with which the PTC cartridge is powered or as a function of the resistance of the PTC cartridge.

In some variations, the electronic control unit is configured to allow the electric power supply of the electric heater if the electric power absorbed by the PTC cartridge is above a predetermined electric power threshold value or if the electric current with which the PTC cartridge is powered is above a predetermined electric current threshold value or if the electrical resistance of the PTC cartridge is below a predetermined resistance threshold value.

In some variations, the electronic control unit is configured to prevent the electric power supply of the electric heater if the electric power absorbed by the PTC cartridge is below the predetermined electric power threshold value or if the electric current with which the PTC cartridge is powered is below a predetermined electric current threshold value or if the electrical resistance of the PTC cartridge is above the predetermined resistance threshold value.

In some variations, the tray includes an electric current meter adapted to measure the electric current with which the PTC cartridge is powered or an electric power meter adapted to measure the electric power absorbed by the PTC cartridge or an electrical resistance meter adapted to measure the electrical resistance of the PTC cartridge.

In some variations, the electronic control unit is configured to detect if the PTC cartridge is wetted by the water in the tray and if the level of water in the tray is below the PTC cartridge, as a function of the electric power absorbed by the PTC cartridge or of the electric power supply current with which the PTC cartridge is powered or of the electrical resistance of the PTC cartridge.

In some variations, the evaporation tray is configured to electrically power the PTC cartridge continuously or at predetermined time intervals.

In some variations, the electronic control unit is configured to measure the electric current with which the PTC cartridge is powered or the electric power absorbed by the PTC cartridge or the resistance of the PTC cartridge, in particular, continuously or at predetermined time intervals.

In some variations, the PTC cartridge is configured to have, when wetted by water, in particular immersed in water, a lower electrical resistance than the electrical resistance it has when it is substantially immersed only in air; in particular, wherein the PTC cartridge is configured to absorb higher electric power and higher electric current than the electric power and the electric current it absorbs when it is substantially immersed only in air, respectively.

In some variations, the electric heater is arranged inside the tray, so as to be wetted by the water contained in the tray.

In some variations, the distance, in particular the minimum distance, between the electric heater and the bottom of the tray is smaller than the distance, in particular the minimum distance, between the PTC cartridge and the bottom of the tray.

In some variations, a refrigerator is provided with an evaporation tray described herein.

In some variations, a method for controlling the operation of an evaporation tray is provided. If the electronic control unit detects that the electric power absorbed by the PTC cartridge is above a predetermined electric power threshold value or if the electronic control unit detects that the electric current with which the PTC cartridge is powered is above a predetermined electric current threshold value or if the electronic control unit detects that the electrical resistance of the PTC cartridge is below a predetermined resistance threshold value, it allows the electric power supply of the electric heater. If the electronic control unit detects that the electric power absorbed by the PTC cartridge is below the predetermined electric power threshold value or if the electronic control unit detects that the electric current with which the PTC cartridge is powered is below the predetermined electric current threshold value or if the electronic control unit detects that the electrical resistance of the PTC cartridge is above the predetermined resistance threshold value, it prevents the electric power supply of the electric heater.

In some variations, if the PTC cartridge is wetted by the water in the tray, the electronic control unit detects that the electric power absorbed by the PTC cartridge is above said predetermined electric power threshold value or the electronic control unit detects that the electric current with which the PTC cartridge is powered is above said predetermined electric current threshold value or the electronic control unit detects that the electrical resistance of the PTC cartridge is below the predetermined resistance threshold value, and/or when the PTC cartridge is substantially immersed only in air, the electronic control unit detects that the electric power absorbed by the PTC cartridge is below said predetermined electric power threshold value or the electronic control unit detects that the electric current with which the PTC cartridge is powered is below said predetermined electric current threshold value or the electronic control unit detects that the electrical resistance of the PTC cartridge is above the predetermined resistance threshold value.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain implementations of the subject matter disclosed herein and, together with the description, help explain some of the principles associated with the disclosed implementations. In the drawings,

FIGS. 1A-1C illustrate example refrigeration systems, consistent with implementations of the current subject matter;

FIG. 2 depicts a system diagram illustrating an evaporator pan system, consistent with implementations of the current subject matter;

FIG. 3A is a perspective view of an example evaporator pan system, consistent with implementations of the current subject matter;

FIG. 3B is a top view of an example evaporator pan system, consistent with implementations of the current subject matter;

FIG. 4 is an example evaporator pan system, consistent with implementations of the current subject matter;

FIG. 5 is an example evaporator pan system, consistent with implementations of the current subject matter;

FIGS. 6A and 6B depict an example evaporator pan system, consistent with implementations of the current subject matter;

FIG. 7A is a block diagram illustrating an example evaporator pan system, consistent with implementations of the current subject matter;

FIG. 7B is an example thermistor, consistent with implementations of the current subject matter;

FIG. 7C is an example thermistor, consistent with implementations of the current subject matter;

FIG. 8 depicts a flowchart illustrating an example of a process for implementing an evaporator pan system, in accordance with some example embodiments;

FIGS. 9A-9C are schematic diagrams illustrating various states of an evaporator pan system, consistent with implementations of the current subject matter; and

FIG. 10 depicts a block diagram illustrating an example of a computing system, in accordance with some example embodiments.

When practical, similar reference numbers denote similar structures, features, or elements.

### DETAILED DESCRIPTION

Drip pans may be used to collect liquid from cooling systems, such as commercial or industrial refrigerators. For example, drip pans may be used when no drain lines are available. In some instances, during a defrost process of the cooling systems or during normal operation of the cooling systems, condensation may form on various components of the cooling systems. The condensation may drip into the drip pans or otherwise be collected by the drip pans. Additionally and/or alternatively, drip pans may be used to collect leakage of the liquid from the cooling systems.

To prevent overflow of the liquid collected by the drip pans, a mechanical switch or float may be used. In this example, the mechanical switch or float may indicate a liquid level within the drip pan, and the liquid may be drained or otherwise removed from the drip pan depending on the liquid level. However, such mechanical switches or floats may be bulky and contain a significant number of moving parts that can lead to mechanical failure or inaccurate liquid level determinations. As a result, use of mechanical switches or floats to indicate the liquid level within drip pans may fail to indicate an accurate liquid level and prevent leakage of liquid from the cooling systems.

In some instances, such mechanical floats or switches can be used with electric current cut-off systems. The systems may be are activated by a float which rises and falls as a function of the rising and falling of the water level and cuts off the electric power supply when the float falls and the water leaves the heating resistor uncovered. On the other hand, when the water level in the tray rises up to cover the resistor, the float also rises in level and closes the current circuit, and the heating resistor resumes producing heat which favors the evaporation of the water. The use of a float creates reliability problems, since it can become blocked due to the presence of scale or due to other reasons and no longer respond accurately.

In some instances, heaters may also be used, as part of an evaporator drip pan, to evaporate liquid collected by the drip pan. In these examples, based on an indicated liquid level, a knob, button, handle, or other mechanical component may be physically manipulated to cause power to be supplied to the heater, which in turn heats the collected liquid, and causes evaporation of the liquid from the drip pan. After a period of time, the knob, button, handle, or other mechanical component may be physically manipulated to cut off the power supply to the heater. However, such systems are unreliable. For example, these systems rely on many mechanical components that have a high likelihood of failure. Also, these systems may lead to overheating of the heater, causing failure of the heater, the drip pan, or other various components of the cooling system, such as when the power supply to the heater is cut off too late. As another example, these systems may not adequately remove (e.g., evaporate) the liquid from the drip pans, such as when the power supply to the heater is cut off too soon.

Further, as another example, in refrigeration systems, during operation, condensation water is produced, which is usually collected in a container, such as a tray, which allows the water collected to evaporate and avoids the need to provide a connection to an external drainage system. It is also useful to speed up the evaporation, in particular when the refrigeration system is large in size and the amount of condensation produced is remarkable. For this purpose, an electric heating resistor can be provided, which is immersed in water and, by heating it, speed up the evaporation thereof.

The evaporator pan system consistent with implementations of the current subject matter may reliably, efficiently, and safely indicate an accurate liquid level within a drip pan, automatically remove the liquid from the drip pan to prevent overflow of the liquid, and/or supply or prevent supply of power to the heater as appropriate to remove a sufficient volume of the liquid from the drip pan, while preventing or limiting overheating of the heater. The evaporator pan system may also have a reduced quantity of moving components (or no moving components). Thus, the evaporator pan control system described herein results in reduced failure. The evaporator pan control system may be manufactured with a reduced cost relative to existing systems. Further, the evaporator pan control system may maintain a reduced profile and save space when used with cooling systems, such as refrigerators, and may be more easily assembled than conventional evaporator pans. Moreover, the evaporator pan system may not include a float or the like for activating and deactivating the heater which heats the condensation water in the tray to evaporate it.

The evaporation pan system can be particularly, but not exclusively, adapted to be used in a refrigerator. While the evaporator pan system is generally described herein as being used with cooling systems such as refrigerators, the evaporator pan system consistent with implementations of the current subject matter may be used with and/or coupled to a boiler or boiler system, an immersion heater, a heat pump, and/or the like. Additionally and/or alternatively, the evaporator pan system can be used with or coupled to a tank or other type of container for various applications, in which a fluid (e.g., water) evaporates or condenses on one or more components of the tank, container, or system. Thus, the evaporator pan system described herein can be used in various applications to collect the fluid while preventing leakage, limiting overheating of the heater, and/or the like.

For example, an evaporator pan system, consistent with implementations of the current subject matter, may include an evaporator pan and an evaporator pan control system coupled to the evaporator pan. The evaporator pan control system may include a controller, a sensor (e.g., a thermistor), and a heating element. The controller may be coupled to the heating element and the sensor, and control the heater based on sensor readings of the sensor. The controller may detect a current passing through the sensor and determine whether the current meets (e.g., is greater than or equal to) a threshold. The current meeting the threshold may indicate a presence of a threshold volume of the liquid within the evaporator pan. Based on a determination that the current meets the threshold, the controller may activate the heating element to cause evaporation of at least a portion of the liquid within the evaporator pan. The controller may supply power to the heating element until the current is detected to be lower than the threshold current (which indicates that the volume of liquid within the pan is below the threshold volume). In some implementations, based on determining the current meets the threshold current, the controller generates an alert.

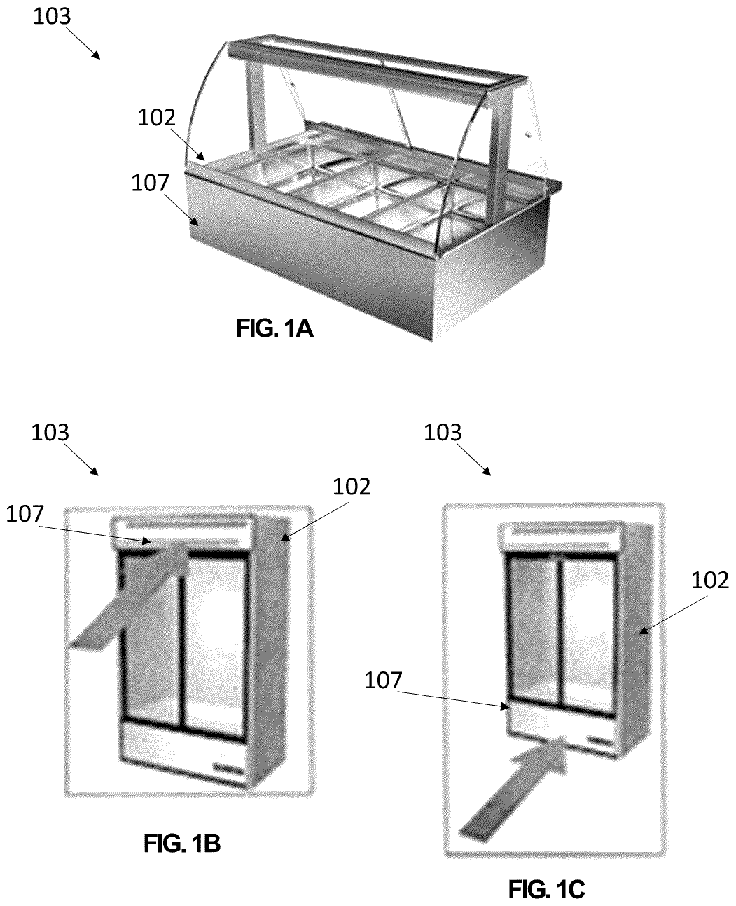

FIGS. 1A-1C depict example refrigeration systems 103, consistent with implementations of the current subject matter. The refrigeration system 103 may include a cooling system 102 and an evaporation pan system 107 coupled to the cooling system 102. The cooling system 102 may include a refrigerator (e.g., a commercial refrigerator, an industrial refrigerator, a residential refrigerator, and/or the like), an air conditioning unit, a boiler, an immersion heater, a heat pump, and/or the like. For example, the cooling system 102 may include one or more pipes or other equipment carrying fluid. Due to a defrosting process, a heat exchange process, and/or the like, a liquid, such as water, may form on the exterior of the pipes or other equipment. The evaporator pan system 107 may collect the liquid (e.g., the condensed liquid) and/or other liquid from the cooling system 102.

FIGS. 1A-1C depict various orientations of the refrigeration system 103. For example, FIG. 1A and FIG. 1C show examples of the refrigeration system 103 in which the evaporator pan system 107 is positioned below the cooling system 102. FIG. 1B shows another example of the refrigeration system 103 in which the evaporator pan system 107 is positioned above the cooling system 102.

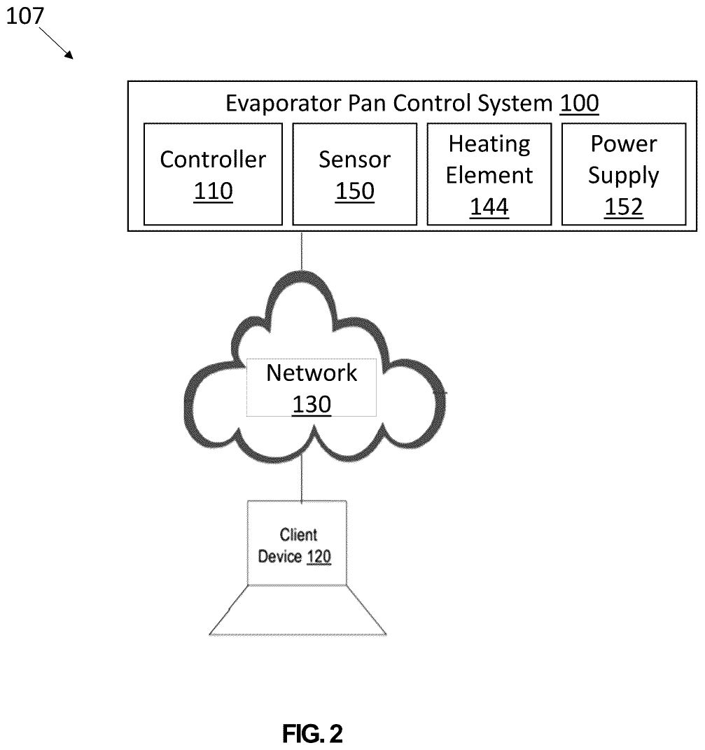

FIG. 2 depicts a network diagram illustrating the evaporator pan system 107, consistent with implementations of the current subject matter. Referring to FIG. 2, the evaporator pan system 107 may include an evaporator pan control system 100 (which may be coupled to an evaporator pan 140) and a client device 120. The client device 120 and the evaporator pan control system 100 may be communicatively coupled via a network 130. The network 130 may be any wired network and/or a wireless network including, for example, a wide area network (WAN), a local area network (LAN), a virtual local area network (VLAN), a public land mobile network (PLMN), the Internet, Bluetooth, and/or the like.

The client device 120 may be a processor-based device including, for example, a smartphone, a tablet computer, a wearable apparatus, a virtual assistant, an Internet-of-Things (IoT) appliance, and/or the like. The client device 120 includes a user interface that may be manipulated by a user. For example, the client device 120 may receive one or more user inputs (e.g., one or more input values, one or more selections, and/or the like) via the user interface. The one or more inputs may include one or more thresholds, and/or the like. The client device 120 may receive one or more alerts, such as from the evaporator pan control system 100, indicating a current meets a threshold current, a volume of liquid within the evaporator pan 140 meets a threshold volume, a heating element has been activated or deactivated, and/or the like.

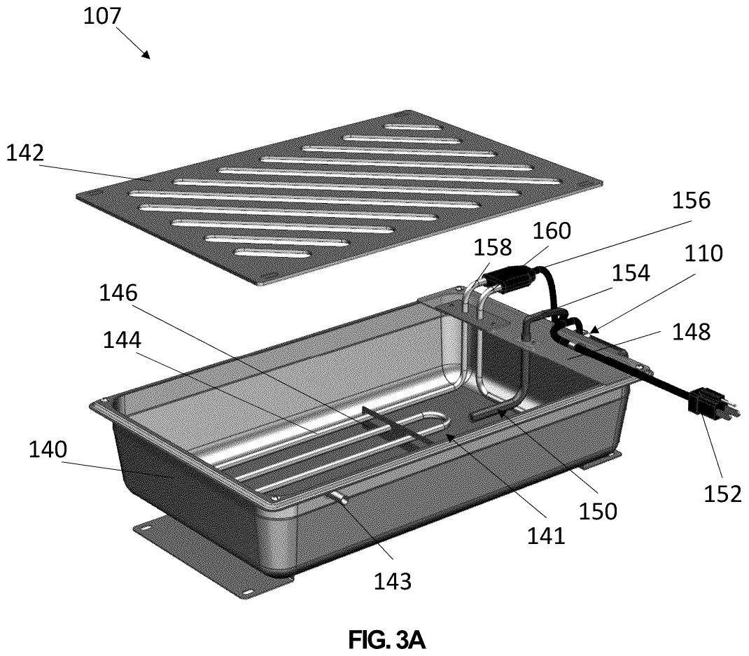

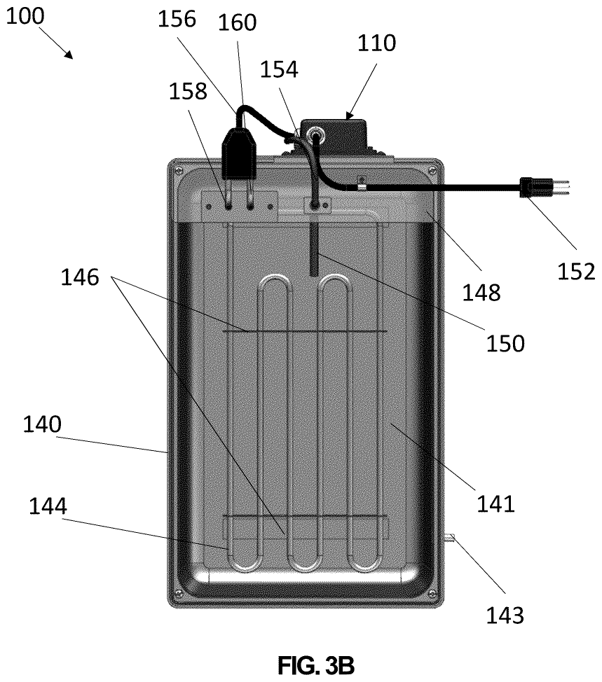

Again referring to FIG. 2, the evaporator pan control system 100 may include a controller 110 (e.g., an electric control unit), a sensor 150, a heating element 144, a power supply 152, and/or the like. As shown in FIGS. 3A and 3B, the evaporator pan control system 100 may be coupled to the evaporator pan 140. While “evaporator pan” or “pan” is used herein to describe evaporator pan 140, other terms, such as “tray” or “evaporator tray” may be used interchangeably to describe evaporator pan 140, consistent with implementations of the current subject matter.

The evaporator pan 140 may have a rectangular or other shape that has an interior volume for collecting liquid, such as water, and/or the like from a cooling system, such as the cooling system 102. The evaporator pan 140 may be made of one or more materials, such as stainless steel, aluminum, plastic, or the like. All or a portion of the evaporator pan control system 100 may be mounted to or otherwise integrated with the evaporator pan 140. For example, the controller 110, the sensor 150, and the heating element 144 may be mounted to the evaporator pan 140.

The sensor 150 may be positioned at least partially within the evaporator pan 140. For example, the evaporator pan 140 may include a mounting shelf 148 positioned at one end of the evaporator pan 140 and covering at least a portion of the interior volume of the evaporator pan 140. The sensor 150 may be mounted to and/or may extend from the mounting shelf 148. The sensor 150 may extend from the mounting shelf 148 towards a base 141 of the evaporator pan 140 and/or across the base 141 of the evaporator pan 140. For example, the sensor 150 may include a first portion that extends perpendicular to the base 141 and a second portion that extends from the first portion and parallel to the base 141, although other configurations are contemplated.

Referring to FIG. 3A and FIG. 3B, the sensor 150 may be coupled, directly or indirectly, to the controller 110, which may be housed within a controller housing and mounted to the evaporator pan 140. For example, the sensor 150 may be coupled, at one end, to the controller 110 via a sensor connector 154 (see FIG. 3B). At the other end, the sensor 150 may be positioned within the interior volume of the evaporator pan 140. The controller 110 may control, in particular to allow or prevent, the electric power supply of the heating element 144.

At least a portion of the sensor 150, such as the second portion of the sensor 150 extending parallel (although other configurations are contemplated) to the base 141 may be spaced from the base 141 of the evaporator pan 140. This allows for at least some liquid to be positioned within the evaporator pan 140, such as between the base 141 and the sensor 150, prior to the sensor 150 detecting the presence of a volume (e.g., a threshold volume) of the liquid within the evaporator pan 140. For example, the spacing between the base 141 and the sensor 150 may correspond to the threshold volume of liquid. As shown in FIGS. 3A and 3B, the sensor 150 may be generally L-shaped. However, other shapes may be contemplated.

The sensor 150 may be a thermistor, such as a positive temperature coefficient (PTC) heater. This may allow for a reduced number of components, reducing the likelihood of failure of the sensor 150. The PTC heater may also be described herein as a “PTC cartridge,” which may be a PTC-effect cartridge. As described herein, the resistance of the PTC heater may increase when the temperature experienced by the PTC heater increase. The sensor 150 may be adapted to be electrically powered, arranged inside the evaporator pan 140, so as to be wetted or touched by the water contained in the pan 140, in particular, adapted to operate as a sensor for the presence of water in the pan.

In some implementations, power may be continuously supplied, such as from the power supply 152, to the sensor 150 to allow for the sensor 150 may continuously detect the presence or absence of the liquid (e.g., a threshold volume of the liquid) within the interior volume of the evaporator pan 140. The PTC heater (e.g., thermistor) may be a semiconductor or a ceramic-based electrical component with temperature-dependent resistance that may be used as a heating element (together or separate from the heating element 144).

In some implementations, the sensor 150 experiences variations in current flowing through the sensor 150 based on a temperature experienced by the sensor 150, such as by at least the second portion of the sensor 150. In other words, the sensor 150 may experience a change in current flowing through the sensor 150 based on contact with a threshold volume of liquid within the evaporator pan 140 due at least in part to the change in temperature experienced by the sensor 150 when the sensor 150 contacts the liquid. For example, when the sensor 150 contacts the liquid, the temperature experienced by the sensor 150 may drop. This occurs since the temperature of the liquid may be lower than the ambient temperature experienced by the sensor 150 when the sensor 150 is not in contact with the liquid.

For example, the PTC heater (e.g., thermistor) 150 has a positive temperature coefficient that allows for an increase in electrical current at lower temperatures than at high temperatures. As the temperature experienced by the PTC heater decreases, such as when the PTC heater contacts a volume of the liquid, such as the threshold volume of the liquid, the PTC heater resistance decreases, and the current flowing through the PTC heater increases. As the temperature experienced by the PTC heater increases, such as during or after evaporation of a sufficient quantity of the liquid within the evaporation pan 140 evaporates such that the volume of the liquid within the pan is below the threshold volume, the natural resistance of the PTC heater increases while its current conductivity and power output decreases until a state of equilibrium is reached and minimal current flows through the PTC heater. Due at least in part to the self-regulating nature of the PTC heater, the PTC heater may not overheat, improving safety and reliability of the sensor 150. The PTC heater may additionally and/or alternatively indicate the volume of liquid within the evaporator pan 140 in an energy-efficient manner with low power consumption and at low heat dissipation.

As described herein, the PTC heater may provide a PTC effect. The PTC effect may, as described herein, discriminate whether the PTC heater or cartridge is wetted by the liquid contained in the pan 140 or if it is not wetted by the fluid (e.g., water). When the PTC heater 150 is not wetted by the fluid in the pan 140, in other words, the PTC heater 150 is substantially immersed only in air, as it occurs when the fluid level in the pan 140 is below the PTC heater 150.

In some implementations, when using the PTC heater, there is a substantial difference in resistance as well as in power supply current, and therefore in absorbed power, between a state in which the PTC heater 150 is (at least in part) touched or wetted by the fluid in the pan 140 and a state in which the PTC heater 150 is dry—in other words, it is not touched nor wetted by the liquid in the pan 140. For example, using a PTC heater 150, there is a substantial difference in resistance, as well as in electric power supply, and therefore in electric power absorbed by the PTC heater 150 between a state in which the PTC heater 150 is not immersed in the liquid in the pan and a state in which the cartridge is immersed (even only partially) in the liquid in the pan 140. Therefore, resistance or electric current or absorbed power values can be indicative of the presence of liquid in the pan, particularly detected by means of the PTC heater 150.

By exploiting the PTC heater 150 as a liquid presence sensor, the pan 140 may, in some implementations, not require, and in particular it may not be provided with, a float or the like for controlling (e.g., via the controller 110) the electric power supply of the electric heater 144.

In some implementations, the PTC heater 150 (e.g., because of the PTC effect described herein) may be configured so that, when it is immersed in liquid, it absorbs a greater electric power (e.g., at least 5 times greater, for example from 5 to 10 times greater), and absorbs a greater electric current (e.g., at least 5 times greater, for example from 5 to 10 times greater), and has a lower electrical resistance (e.g., at least 5 times lower, for example from 5 to 10 times lower), than the electric power and the electric current it absorbs, and than the electrical resistance it has when substantially immersed only in air, respectively.

For example, the PTC heater 150 can be configured to absorb a power equal to or approximately equal to 4 W, such as when it is substantially immersed only in air; and/or the PTC heater 150 can be configured to absorb an electric power equal to or approximately equal to 20 W, such as when it is wetted by the liquid in the pan 140.

The PTC heater 150 can be adapted to generate heat (e.g., very little heat in some implementations) when it is electrically powered. The PTC heater 150 may heat up less, in particular much less, than the heating element 144.

The PTC heater 150 and the heating element 144 may be distinct or separate from each other. In some implementations, the heating element 144 is dedicated to heating the liquid in the pan 140, and the PTC heater 150 is adapted to be used as a liquid presence sensor.

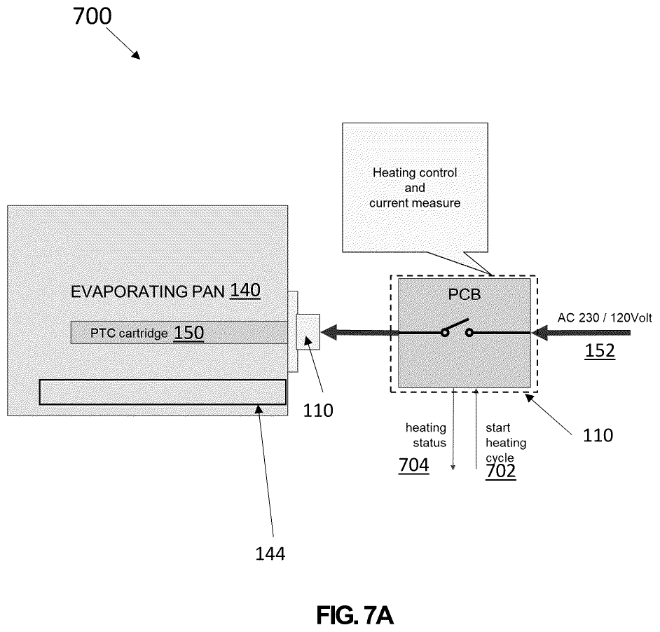

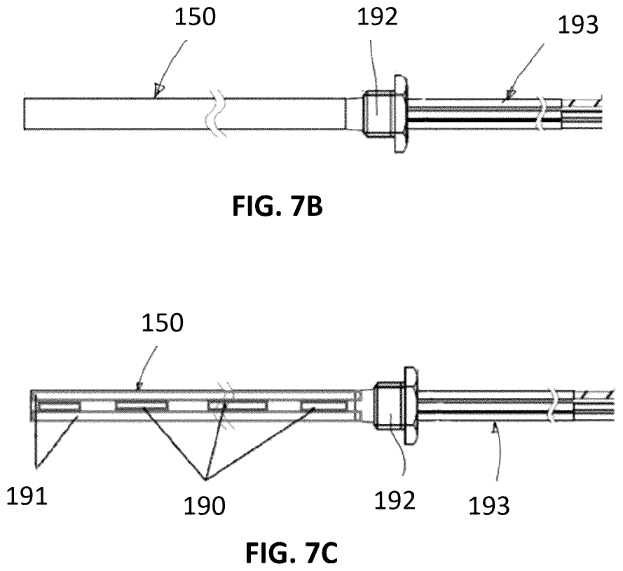

FIGS. 7B and 7C illustrate example PTC heaters 150, consistent with implementations of the current subject matter. As shown in FIGS. 7B and 7C, the PTC heater 150 includes (e.g., contains) one or more resistors 190 or PTC-effect resistors therein (also referred to herein as PTC pads). On some implementations, the PTC pads 190 increase the resistance coefficient as the temperature of the PTC resistor 190 itself increases.

In some implementations, the PTC heater 150 includes one or more metal bodies 191. The one or more metal bodies 191 may be made of aluminum. The one or more metal bodies 191 may be adapted to conduct current to said one or more PTC-effect heating resistors 190.

A non-limiting example of a PTC heater 150 provided with PTC pads 191 is shown in greater detail in FIGS. 7B and 7C. As an example, the current is transmitted to the PTC pads 190 by means of two bodies 191 (e.g., two aluminum profiles 191). The one or more metal bodies 191 may have a semicircular cross-section. Other forms of PTC heaters are also contemplated.

Referring to FIGS. 7B and 7C, the PTC heater 150 may be fixed vertically to a wall of the pan 140, for example by means of a locking ring 192.

The PTC heater 150 may have a cylindrical shape. The PTC heater 150 may be provided with a junction which is threaded at the base.

The controller 110 may be configured to control, in particular to allow or prevent, the electric power supply of the heating element 144 as a function of a predetermined liquid level (in the pan 140). Said predetermined liquid level can be defined by the PTC heater 150, in particular by the position of the end 193 of the PTC heater 150 proximal to the bottom of the pan 140. When the liquid level in the pan 140 is above the level of the heater 150, the heating element 144 is activated, (e.g., electrically powered), producing heat for the evaporation of the liquid, and when the liquid level in the pan 140 is below the level, the heating element 144 is deactivated (e.g., not electrically powered), whereby it does not generate heat.

The heating element 144 (e.g., an electric heater) may be at least partially positioned within the evaporator pan 140. The heating element 144 may be configured to heat the liquid within the evaporator pan 140, such as at a temperature that causes evaporation of the liquid. For example, the heating element 144 may be adapted to generate heat when it is electrically powered, arranged so as to heat the water or other fluid contained in the evaporator pan 140, in particular to evaporate it. This removes at least some (or all) of the liquid within the evaporator pan 140 to reduce or prevent overflow of the liquid from the evaporator pan 140. The heating element 144 may heat at least a portion of the liquid in contact with the heating element 144, the liquid within a threshold distance from the heating element 144, and/or the entire volume of liquid within the evaporator pan 140.

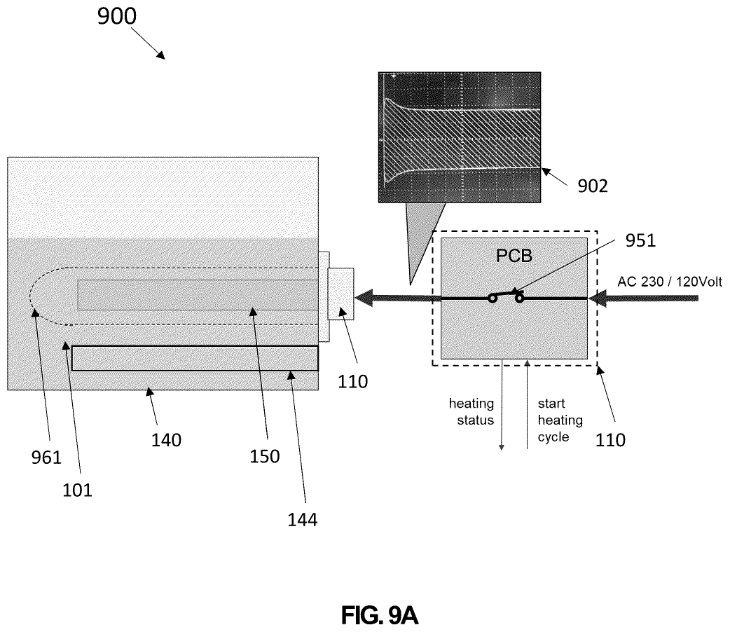

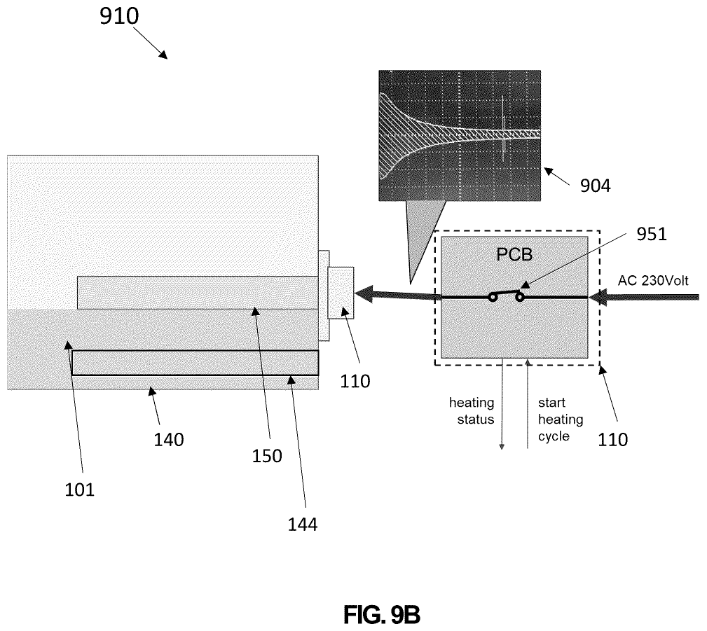

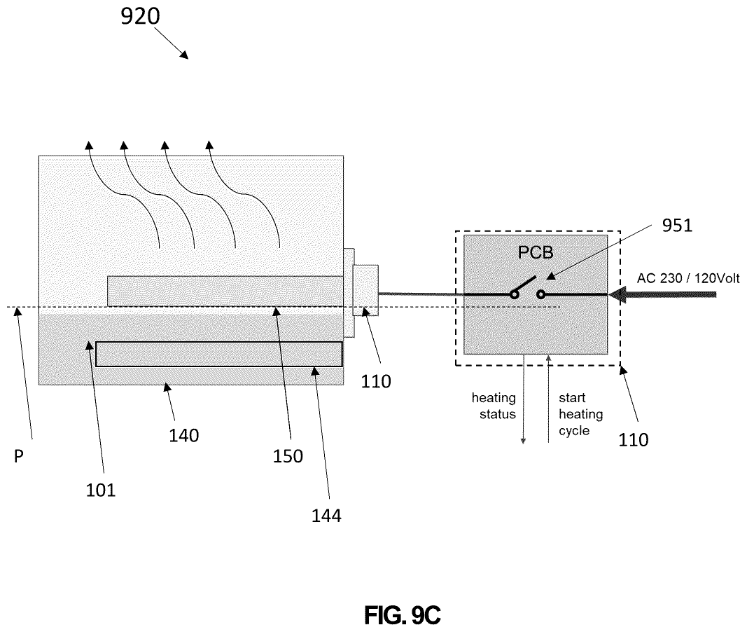

The heating element 144 may be a resistive heater, a wire heater, an electric heater, an armored resistor (e.g., with an outer metal armor, such as a steel armor) or the like. The heating element 144 may be positioned within a tube or outer housing 961 (see FIG. 9A). The tube or outer housing 961 may enclose the thermistor 150. The housing 961 may include a thermally insulating structure or shield or thermally insulating element. For example, housing 961 can be a pipe made of a low conductivity material, e.g., stainless steel, or a cover consisting of a sheath of glass wool or ceramic wool or another thermally insulating material. The housing 961, when provided, allows in any case the fluid in the pan 150 to wet the thermistor 150. As an example, the housing 961 can be provided with a plurality of holes or openings. For example, the holes can be made in the metal pipe or, in the case of an insulation of the glass wool or ceramic wool type, or of a similar insulating material, it is the porous structure of the material itself which ensures that the water can however wet the surface of the thermistor 150.

The use of the housing 961 may increase the difference between the electric power absorbed (and power supply current and resistance of the thermistor 150) when the thermistor 150 is at least partially wetted by the fluid in the pan 140, and when the thermistor 150 is not wetted by fluid.

The heating element 144 may be coupled to the sensor 150 via the controller 110. The heating element 144 may incorporate the sensor 150. For example, the sensor 150 may additionally and/or alternatively be positioned at least partially within the tube or outer housing. The heating element may generate heat by means of the Joule effect.

FIGS. 3A and 3B illustrate an example of the heating element 144. The heating element may be separate from and/or form a part of the sensor 150. The heating element 144 may have one or more curved and/or straight portions. The heating element 144 may extend across the base 141. The heating element 144 may be supported by a heater mount 146 within the interior volume of the evaporator pan 140. The heater mount 146 may space the heating element 144 from the base 141 and allow the heating element 144 to extend parallel to or otherwise spaced apart from the base 141. This allows for at least some liquid to be positioned within the evaporator pan 140, such as between the base 141 and the heating element 144. The spacing between the base 141 and the heating element 144 may correspond to the threshold volume of liquid. In some implementations, the threshold volume of the liquid is above the heating element 144 such that the heating element 144 is partially or entirely surrounded by the liquid when the volume of the liquid meets the threshold volume of liquid.

In some implementations, the heating element 144 is positioned along the same plane as at least a portion of the sensor 150, such as the second portion. In other implementations, the heating element 144 is positioned closer to the base 141 than the sensor 150. This allows for the heating element 144 to be surrounded by the liquid, but still below the sensor 150 until the volume of the liquid meets the threshold volume of liquid, such as when the liquid contacts and/or at least partially surrounds the sensor 150.

The heating element 144 may be include a heating portion positioned parallel (or other configuration) to the base 141 and a connector portion 156 extending between the heating portion and a connector 156 that connects the connector portion to the controller 110. As shown in FIG. 3B, the connector portion 156 may include a first terminal 158 and a second terminal 160. The heating portion extends between the first terminal 158 and the second terminal 160. The first and second terminals 158, 160 may be a positive and/or negative terminal. The connector 156 connects both the first and second terminals 158, 160 to the controller 110. In some implementations, the heating element 144 is mounted to the mounting shelf 148, such as via the first and second terminals 158, 160.

Referring again to FIG. 3A, the interior volume of the evaporator pan 140 may be covered by a cover 142. The cover 142 may include one or more slots that allows the liquid to pass into the interior volume of the evaporator pan 140 and/or the evaporated liquid to exit the evaporator pan 140.

Again referring to FIGS. 3A and 3B, the evaporator pan 140 may include an overflow port 143. The overflow port 143 may provide a failsafe for the liquid to exit the evaporator pan 140, such as when the liquid reaches the overflow port 143.

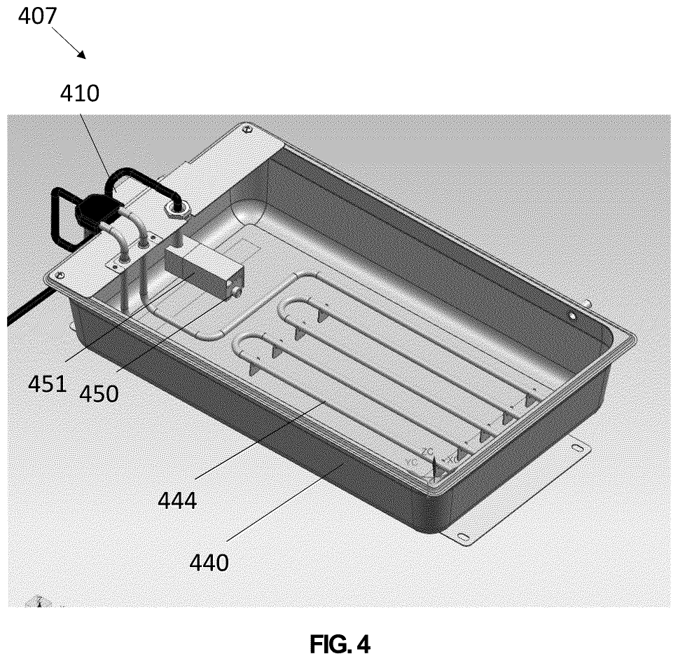

FIG. 4 illustrates an example of an evaporator pan system 407, consistent with implementations of the current subject matter. The evaporator pan system 407 may be the same as or similar to the evaporator pan system 107, and may include one or more components that may be used in place of and/or together with one or more components of the evaporator pan system 107. For example, the evaporator pan system 407 may include an evaporator pan 440, a heating element 444, a sensor 450, and a controller 410, which are the same as or similar to the evaporator pan 140, the heating element 144, the sensor 150, and the controller 110, respectively. The evaporator pan system 407 may additionally and/or alternatively include a sensor housing 451 that surrounds at least a portion of the sensor 450, such as the second portion of the sensor 450 that extends approximately parallel (or other configuration) to the base of the evaporator pan 440.

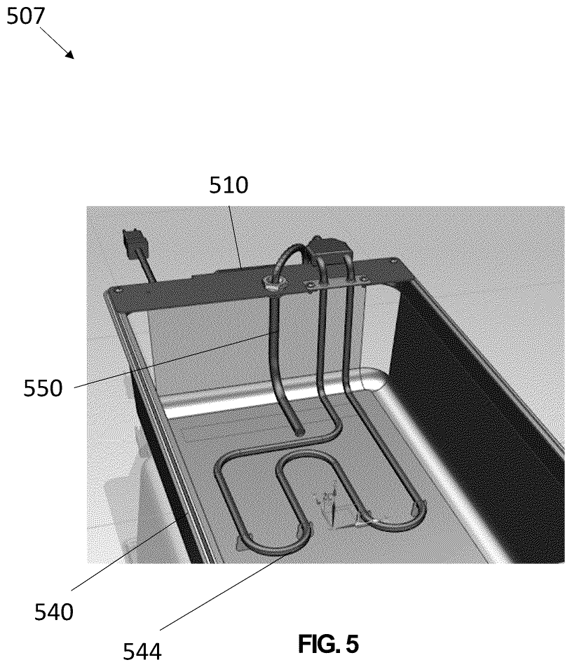

FIG. 5 illustrates an example of an evaporator pan system 507, consistent with implementations of the current subject matter. The evaporator pan system 507 may be the same as or similar to the evaporator pan system 107, 407 and may include one or more components that may be used in place of and/or together with one or more components of the evaporator pan system 107, 407. For example, the evaporator pan system 507 may include an evaporator pan 540, a heating element 544, a sensor 550, and a controller 510, which are the same as or similar to the evaporator pan 140, 440 the heating element 144, 444, the sensor 150, 450, and the controller 110, 410, respectively. The evaporator pan system 507 shows the heating element 544 and the sensor 550 in an alternative configuration and orientation compared to the heating element 144 and the sensor 450.

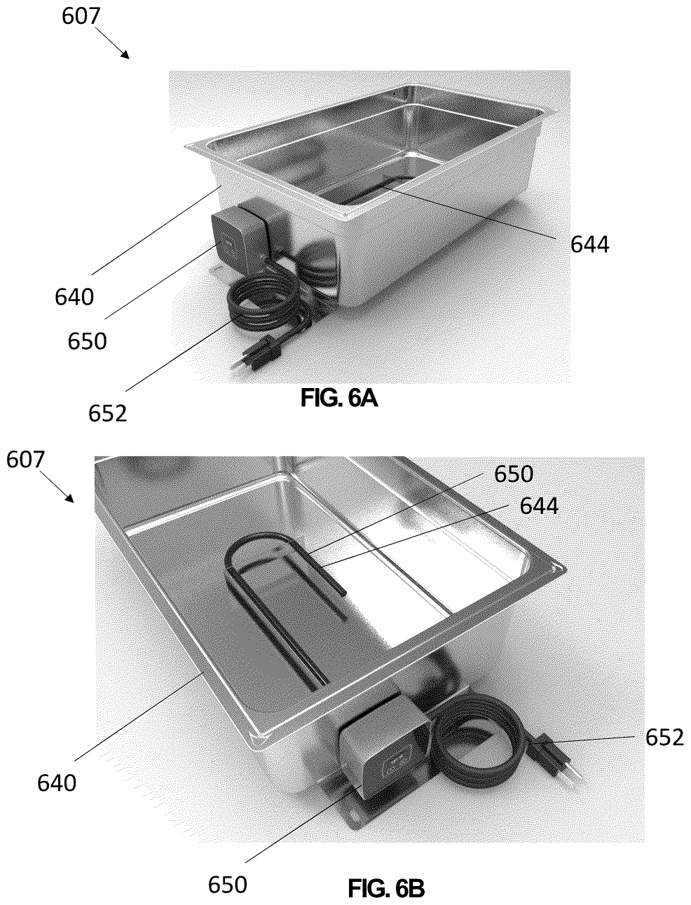

FIG. 6A and FIG. 6B illustrates an example of an evaporator pan system 607, consistent with implementations of the current subject matter. The evaporator pan system 607 may be the same as or similar to the evaporator pan system 107, 407, 507 and may include one or more components that may be used in place of and/or together with one or more components of the evaporator pan system 107, 407, 507. For example, the evaporator pan system 607 may include an evaporator pan 640, a heating element 644, a sensor 650, a controller 610, and a power supply 652, which are the same as or similar to the evaporator pan 140, 440, 540 the heating element 144, 444, 544 the sensor 150, 450, 550, the controller 110, 410, 510, and the power supply 152, respectively.

The evaporator pan system 607 shows an example of the evaporator pan control system in which the heating element 644 and the sensor 650 form a part of the same component. For example, the heating element 644 and the sensor 650 may be coupled to one another, and positioned within the same tube. Additionally and/or alternatively, the sensor 650, such as the PTC heater, may also be the heating element 644. For example, when the sensor 650 (e.g., the PTC heater) detects a change in current that meets the threshold current, the controller 610 causes power to be supplied to the sensor 650 (e.g., the PTC heater) to activate the sensor 650, thereby heating the liquid within the evaporator pan 640 for evaporating the liquid. Such configurations may further reduce components, and increase reliability.

Referring back to FIGS. 2, 3A, and 3B, the controller 110 may be enclosed within a controller housing and mounted to the evaporator pan 140, such as at an exterior of the evaporator pan 140. The controller 110 may include a printed circuit board or printed circuit board assembly.

The controller 110 may include at least one data processor and at least one memory storing instructions, which when executed by the at least one data processor are configured to execute one or more operations. For example, the controller 110 may (e.g., automatically) control the heating element 144 and/or the power supply 152 based on readings from the sensor 150.

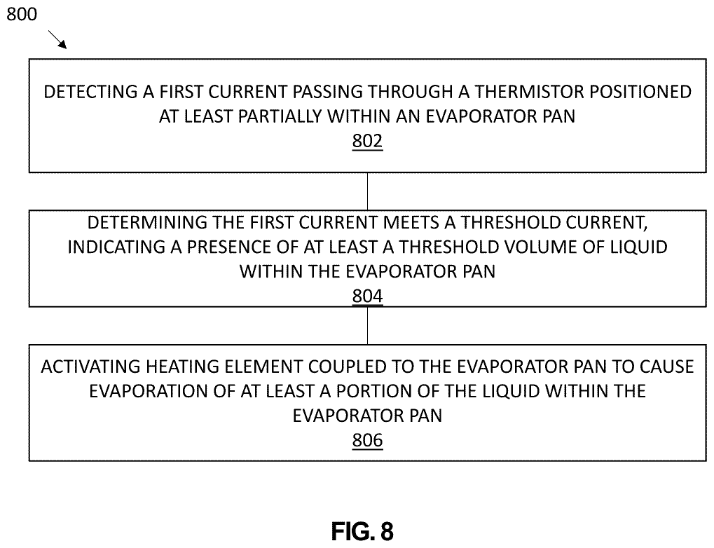

FIG. 8 depicts a flowchart illustrating a process 800 for implementing an evaporator pan control system (e.g., the evaporator pan control system 100) to control evaporation of a liquid within an evaporator pan (e.g., the evaporator pan 140), consistent with implementations of the current subject matter. While the process 800 is described with respect to the evaporator pan system 107, the process 800 may similarly be performed by the evaporator pan system 407, 507, 607. Referring to FIGS. 1-9C, one or more aspects of the process 800 may be performed by the evaporator pan system 107, the controller 110, other components therein, and/or the like.

Further, FIGS. 7A and 9A-9C schematically illustrate various aspects of the process 800, consistent with implementations of the current subject matter. For example, FIG. 7A is a block diagram 700 schematically illustrating an example of the evaporator pan system 107, consistent with implementations of the current subject matter and FIGS. 9A-9C are schematic diagrams illustrating various states of the evaporator pan system 107, consistent with implementations of the current subject matter.

As shown in FIGS. 7 and 9A-9C, the diagram 700 includes the evaporation pan 140, the sensor 150 (e.g., a thermistor such as a PTC heater), heating element 144, the controller 110, and the power supply 152. The evaporator pan 140 may include at least one of aluminum, stainless steel, plastic, and/or the like. The evaporator pan 140 may be used with and/or coupled to at least one of a refrigerator, a boiler, an immersion heater, and a heat pump, and/or the like.

As noted, the thermistor (e.g., PTC heater) 150 and the heating element 144 may be at least partially positioned within the interior volume of the evaporator pan 140. The thermistor 150 may continuously receive power from the power supply 152 so that the thermistor 150 may continuously be used (e.g., by the controller 110) to determine a liquid level or liquid volume of the liquid within the interior volume of the evaporator pan 140.

The heating element 144 may include a resistive heating wire, or other heater. The heating element 144 receives power from a power supply 152 to activate the heating element 144 (e.g., turns on the heating element 144). The heating element 144 may also deactivate when the power supply 152 is cut off from the heating element 144 or power is otherwise prevented from being supplied to the heating element 144.

The heating element 144 may heat a liquid (e.g., water, and/or the like) within the evaporator pan 140 to cause evaporation of the liquid or otherwise remove the liquid from the evaporator pan 140. This helps to prevent overflow of the liquid from the evaporator pan 140. The heating element 144 may be coupled to the thermistor 150, such as via the controller 110. In some implementations, the thermistor 150 includes the heating element 144 or acts as the heating element 144. In some implementations, the heating element 144 and the thermistor 150 are positioned within a single tube and/or are separately positioned within the interior volume of the evaporator pan 140. For example, the heating element 144 may surround at least a portion of the thermistor 150. The heating element 144 may be positioned closer to the base of the evaporator pan 140 than the thermistor 150, positioned at the same level as the thermistor 150, and/or the like.

As shown in FIG. 7A, at 702, the controller 110 causes power to be supplied from the power supply 152 to the heating element 144 based on one or more sensor readings (e.g., current readings, such as alternating current readings, temperature readings, and/or the like) from the sensor 150. The controller 110 may additionally and/or alternatively prevent or limit power from being supplied from the power supply 152 to the heating element 144 based on the one or more sensor readings from the sensor 150. At 704, the controller 110 is shown as generating an alert based on detecting a presence or absence of a threshold volume of liquid within the evaporator pan 140.

For example, referring to FIG. 8, at 802, the controller 110 may detect a first current passing through the thermistor 150. The first current corresponds to a decreased temperature experienced by the thermistor 150. For example, when the thermistor 150 contacts or is at least partially surrounded by the liquid within the evaporator pan 140, the thermistor 150 experiences a temperature change. In some implementations, since the liquid is cooler than ambient temperatures, the thermistor 150 experiences a decrease in temperature based on the liquid contacting or at least partially surrounding at least a portion of the thermistor 150.

The temperature change (e.g., decrease in temperature, such as by a predetermined amount) is associated with a volume of the liquid within the evaporator pan 140 meeting a threshold volume of the liquid within the evaporator pan 140. The thermistor 150 may be positioned such that the liquid contacts and/or at least partially surrounds the thermistor 150 when the volume of the liquid within the evaporator pan 140 meets (e.g., is greater than or equal to) the threshold volume. The threshold volume of the liquid corresponds to a threshold current passing through the thermistor 150. For example, as noted herein, the current passing through the thermistor 150 increases based on a corresponding drop in temperature experienced by the thermistor 150.

At 804, the controller 110 receives the sensor readings (e.g., the current, the temperature, and/or the like) from the thermistor 150. The controller 110 may determine whether the first current meets (e.g., is greater than or equal to) the threshold current (which may be predefined). The first current meeting the threshold current indicates a presence of the threshold volume of the liquid within the evaporator pan 140. The controller 110 may continuously or periodically (e.g., in set intervals) determine whether the first current meets the threshold current.

Based at least on a determination the first current fails to meet the threshold current, the controller 110 continues to monitor the temperature of the thermistor 150 and/or the current passing through the thermistor 150. This indicates that the volume of liquid does not meet the threshold volume of liquid.

In some implementations, however, the controller 110 determines the first current meets the threshold current. As an example, FIG. 9A shows a diagram 900 in which the volume of a liquid 101 within the evaporator pan 140 meets the threshold volume, since the liquid, in this example, surrounds at least a portion of the thermistor 150. Also, as shown in FIG. 9A, the volume of liquid surrounds the heating element 144 such that the heating element 144 is at least partially submerged within the liquid. The graph in 902 shows an operating condition in which the liquid in the pan wets at least a part of the thermistor 150. The graph 902 in FIG. 9A shows that the controller 110 determines the current passing through the thermistor 150 is high due at least in part to the decrease in temperature experienced by the thermistor 150.

Referring back to FIG. 8, at 806, the controller 110 activates the heating element 144 to cause evaporation of at least a portion of the liquid within the evaporator pan 140 based at least on determining the first current meets the threshold current. For example, the controller 110 may cause power to be supplied to the heating element 144 to increase a temperature of the heating element 144 and heat the liquid in contact with or surrounding the heating element 144, and/or the entirety of the liquid positioned within the evaporator pan 140.

FIG. 9B illustrates a diagram 910 showing that as the heating element 144 causes evaporation of the liquid from the interior volume of the evaporator pan 140, the volume of liquid within the evaporator pan 140 decreases. The graph 904 shows an operating condition in which the fluid level in the pan is below the thermistor 150, and therefore the thermistor 150 is not wetted by the fluid in the pan (e.g., it is substantially immersed only in air). As shown in the graph 904, as the liquid level decreases, the current passing through the thermistor 150 and detected by the controller 110 similarly decreases. Further, as the liquid level decreases, the temperature experienced by the thermistor 150 rises, as the temperature returns to the ambient temperature. This causes the current passing through the thermistor 150 to increase. In some implementations, the controller 110 continuous to supply at least some power to the heating element 144 for a period of time (e.g., a predefined period of time) after the controller 110 determines the first current is below the threshold current. This allows for evaporation of additional liquid 101 from within the evaporator pan 140, such as until all of the liquid is evaporated or otherwise removed from the evaporator pan 140.

Additionally and/or alternatively, the controller 110 causes power to be supplied to the heating element 144 until a second current (e.g., the current flowing through the thermistor 150) is detected by the controller 110 that is lower than the threshold current. In some implementations, the decrease from the first current to the second current corresponds to an increase in temperature experienced by the thermistor 150. The increase in temperature may be proportional to the decrease in current. The increase in temperature may raise a resistance of the thermistor 150, and in turn decreases the current passing through the thermistor 150. The increase in temperature may also indicate the volume of liquid is less than the threshold volume of liquid.

The controller 110 may determine (e.g., based on one or more sensor readings from the thermistor 150) the second current passing through the thermistor 150 the temperature experienced by the thermistor 150, and/or the like. The controller 110 may determine the second current fails to meet the threshold current, such as based on the detected second current. The second current failing to meet the threshold current indicates a volume of the liquid within the evaporator pan 140 is less than the threshold volume of liquid.

Based on the determination that the second current fails to meet the threshold current (e.g., after determining the first current meets the threshold current), the controller 110 may reduce or prevent power from being supplied to the heating element 144. For example, the controller 110 may reduce the power for a period of time after detecting the second current fails to meet the threshold current or immediately prevent power from being supplied to the heating element 144 after determining the second current fails to meet the threshold current. The controller 110 may decrease the power until the liquid within the evaporator pan 140 has been evaporated or otherwise removed from the evaporator pan.

FIG. 9C illustrates a diagram 920, consistent with implementations of the current subject matter. As shown in FIG. 9C, when the current decreases, such as by a determined amount, the controller 110 prevents power from being supplied to the heating element 144 or otherwise switches off the heating element 144. As shown, this occurs when the liquid level falls below the threshold volume. In some implementations, this occurs when the liquid level falls below the threshold volume by a predetermined volume.

As an example, the controller 110 is configured to allow or prevent (or, in other words, to activate or deactivate) the electric power supply of the heating element 144 as a function of the electric power absorbed by the thermistor 150 or the electric current with which the thermistor 150 is powered or the electrical resistance of the thermistor 150.

The controller 110 can be configured to allow or prevent (or, in other words, to activate or deactivate) the electric power supply of the heating element 144 as a function of one or more of: the electric power absorbed by the thermistor 150, the electric current with which the PTC cartridge 2 is powered or the electrical resistance of the thermistor 150.

The controller 110 is configured to allow the electric power supply of the heating element 144 if the electric power absorbed by the thermistor 150 is above a predetermined electric power threshold value or if the electric current with which the thermistor 150 is powered is above a predetermined electric current threshold value or if the electrical resistance of the thermistor 150 is below a predetermined resistance value; and the controller 110 is configured to prevent the electric power supply of the heating element 144 if the electric power absorbed by the thermistor 150 is below the predetermined electric power threshold value or if the electric current with which the thermistor 150 is powered is below the predetermined electric current threshold value or if the electrical resistance of the thermistor 150 is above the predetermined resistance threshold value.

In order to control (e.g., allow or prevent) the electric power supply of the heating element 144, the controller 110 may include a switch 951 (see FIGS. 9A-9C). The switch 951 may be an electromechanical switch, for example a relay.

The controller 110 may measure the electric current with which the thermistor 150 is powered and/or the electric power absorbed by the thermistor 150 and/or the electrical resistance of the thermistor 150. The controller 110 can be particularly configured to carry out said measurement continuously or at predetermined time intervals, preferably continuously.

The evaporator pan 140 may include an electric current meter (not shown) adapted to measure the electric current with which the thermistor 150 is powered, and/or an electric power meter (not shown) adapted to measure the electric power absorbed by the thermistor 150, and/or an electrical resistance meter (not shown) adapted to measure the electrical resistance of the thermistor 150.

In particular, by virtue of the PTC effect of the thermistor 150, the controller 110 can be configured to detect if the thermistor 150 is wetted by the fluid in the pan 150 and if the fluid level in the pan 140 is below the thermistor 150 (or, in other words, if the thermistor 150 is substantially immersed only in air), as a function of the electric power absorbed by the thermistor 150 or the electric power supply current with which the thermistor 150 is powered or the electrical resistance of the thermistor 150.

In some implementations, if the thermistor 150 is wetted by fluid in the pan 140, the heating element 144 is activated (e.g., it is electrically powered) to heat the water in the pan 140. In some implementations, if the thermistor 150 is not wetted by water in the pan 140, the heating element 144 is deactivated (e.g., it is not electrically powered). In particular, if the thermistor 150 is not wetted by water, the heating element 144 can be deactivated or kept deactivated.

The evaporator pan system (e.g., the controller 1105), can be configured, for example, to electrically power the thermistor 150 continuously or at predetermined time intervals.

The heating element 144 can be arranged inside the pan 140 so that it can be wetted by the water contained in the pan, in particular to evaporate it.

In some implementations, the distance (e.g., the minimum distance) between the heating element 144 and the bottom of the pan is smaller than the distance (e.g., the minimum distance) between the thermistor 150 and the bottom of the pan 140. In other words, the heating element 144 extends farther below (e.g., towards the bottom) with respect to the thermistor 150.

This configuration prevents the heating element 144 from operating dry. In fact, as already mentioned, when the water level is below the thermistor 150, the heating element 144 is not electrically powered, thereby, in this condition, it does not supply heat due to the evaporation of the water in which it is immersed.

In some implementations, the controller 110 may generate an alert. For example, the controller 110 may transmit the alert to the client device 120. The alert may be an audio, audiovisual, visual, vibrational, or other alert. The alert may include a status of the heating element 144. For example, the controller 110 may indicate whether the heating element 144 has been activated or deactivated, how long the heating element 144 has been activated or deactivated, the time at which the heating element 144 has been activated or deactivated, and/or the like.

The alert may additionally and/or alternatively indicate the presence or absence of liquid (e.g., a threshold volume of the liquid) within the evaporator pan 140. For example, the controller 110 may generate the alert based on determining the first current meets the threshold current, the second current falls below the threshold current, the first current fails to meet the threshold current, and/or the like. The controller 110 may generate the alert periodically (e.g., in predefined intervals) to indicate a status of the heating element 144 and/or the thermistor 150, and/or upon such determinations. The alert may generally indicate to the user that the heating element 144 is activated or deactivated. The alert may additionally and/or alternatively indicate a time to check whether the heating element 144 is still activated to prevent overheating of the heating element 144. The alert may additionally and/or alternatively be used to indicate when there is a leakage within the cooling system 102 such that the heating element 144 cannot evaporate the liquid quickly enough. For example, the alert can indicate when there is greater than or equal to a threshold or higher threshold amount of fluid collected within the pan, when a flow rate of the fluid is higher than a threshold (e.g., as measured by a sensor coupled to the pan), and/or the like. Thus, the alert may indicate when intervention is needed or when there is a failure of one or more components of the evaporator pan system 107. This helps to prevent overflow or damage to the evaporator pan system 107.

Accordingly, the evaporator pan system 107 including the evaporator pan 140 and the integrated evaporator pan control system 100 as described herein may reliably, safely, effectively, and automatically remove the liquid from the evaporator pan to prevent overflow of the liquid, prevent failure of the system, and/or the like.

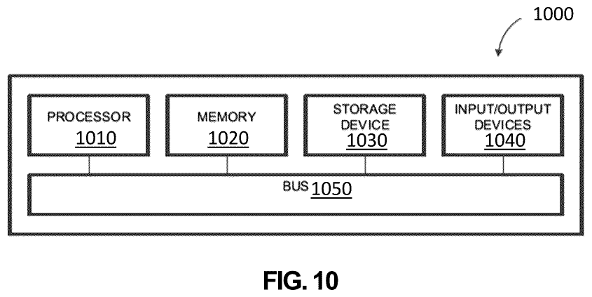

FIG. 10 depicts a block diagram illustrating a computing system 1000, in accordance with some example embodiments. Referring to FIGS. 1-9C, the computing system 1000 can be used to implement the evaporator pan control system 100, the controller 110, and/or any components therein.

As shown in FIG. 10, the computing system 1000 can include a processor 1010, a memory 1020, a storage device 1030, and an input/output device 1040. The processor 1010, the memory 1020, the storage device 1030, and the input/output device 1040 can be interconnected via a system bus 1050. The processor 1010 is capable of processing instructions for execution within the computing system 1000. Such executed instructions can implement one or more components of, for example, the refrigeration system 103, evaporator pan control system 100, the controller 110, and/or any components therein. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

### Terminology

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Additionally, section headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

1. An evaporator pan system, comprising:
an evaporator pan;
a heating element at least partially positioned within the evaporator pan, the heating element configured to heat a liquid within the evaporator pan to cause evaporation of the liquid;
a thermistor positioned at least partially within the evaporator pan; and
a controller coupled to the heating element and the thermistor, wherein the controller includes at least one data processor; and at least one memory storing instructions, which when executed by the at least one data processor, are configured to cause operations including:
detecting a first current passing through the thermistor;
determining the first current meets a threshold current, wherein the first current meeting the threshold current indicates a presence of a threshold volume of the liquid within the evaporator pan; and
activating, based on determining the first current is greater than the threshold current, the heating element to cause evaporation of at least a portion of the liquid within the evaporator pan.

2. The evaporator pan system of claim 1, wherein the thermistor is a positive temperature coefficient (PTC) heater.

3. The evaporator pan system of claim 1, wherein the first current corresponds to a decreased temperature experienced by the thermistor, wherein the decreased temperature is associated with a volume of the liquid within the evaporator pan meeting the threshold volume, and wherein at least the portion of the liquid is in contact with the thermistor when the volume of the liquid within the evaporator pan meets the threshold volume of the liquid.

4. The evaporator pan system of claim 1, wherein the operations further include: supplying power to the heating element until a second current is detected that is lower than the threshold current.

5. The evaporator pan system of claim 4, wherein the operations further comprise:
detecting the second current passing through the thermistor; and
determining, based on the detected second current, the second current fails to meet the threshold current, wherein the second current failing to meet the threshold current indicates a volume of the liquid is less than the threshold volume of the liquid.

6. The evaporator pan system of claim 5, wherein the operations further comprise: reducing power to the heating element or preventing power from being supplied to the heating element based on determining the second current fails to meet the threshold current.

7. The evaporator pan system of claim 5, wherein a decrease from the first current to the second current corresponds to an increase in temperature experienced by the thermistor, wherein the increase in temperature raises a resistance of the thermistor, and wherein the increase in temperature indicates the volume of the liquid is less than the threshold volume of the liquid.

8. (canceled)

9. The evaporator pan system of claim 1, wherein the operations further include: generating an alert based on determining the first current meets a threshold current.

10-11. (canceled)

12. The evaporator pan system of claim 1, wherein the thermistor includes the heating element.

13-17. (canceled)

18. The evaporator pan system of claim 1, wherein at least a portion of the heating element is spaced apart from a base of the evaporator pan, allowing at least some of the liquid to be positioned between the base and the heating element without contacting the heating element, and wherein the spacing between the base of the evaporator pan and at least the portion of the heating element corresponds to the threshold volume of the liquid.

19-20. (canceled)

21. The evaporator pan system of claim 1, further comprising at least one of a refrigerator, a boiler, an immersion heater, and a heat pump.

22. A computer-implemented method, comprising:
detecting, by a controller, a first current passing through a thermistor of an evaporator pan control system coupled to an evaporator pan, wherein the evaporator pan control system comprises: a heating element at least partially positioned within the evaporator pan, the heating element configured to heat a liquid within the evaporator pan to cause evaporation of the liquid; the thermistor positioned at least partially within the evaporator pan; and the controller, wherein the controller is coupled to the heating element and the thermistor;
determining, by the controller, the first current meets a threshold current, wherein the first current meeting the threshold current indicates a presence of a threshold volume of the liquid within the evaporator pan; and
activating, by the controller and based on determining the first current is greater than the threshold current, the heating element to cause evaporation of at least a portion of the liquid within the evaporator pan.

23. The method of claim 22, wherein the thermistor is a positive temperature coefficient (PTC) heater.

24. (canceled)

25. The method of claim 22, further comprising: supplying power to the heating element until a second current is detected that is lower than the threshold current.

26. The method of claim 25, further comprising:
detecting the second current passing through the thermistor; and
determining, based on the detected second current, the second current fails to meet the threshold current, wherein the second current failing to meet the threshold current indicates a volume of the liquid is less than the threshold volume of the liquid.

27. The method of claim 26, further comprising: reducing power to the heating element or preventing power from being supplied to the heating element based on determining the second current fails to meet the threshold current.

28. The method of claim 26, wherein a decrease from the first current to the second current corresponds to an increase in temperature experienced by the thermistor, wherein the increase in temperature raises a resistance of the thermistor, and wherein the increase in temperature indicates the volume of the liquid is less than the threshold volume of the liquid.

29-32. (canceled)

33. The method of claim 22, wherein the thermistor includes the heating element.

34-43. (canceled)

44. An evaporation tray for condensation water, in particular for a refrigerator, comprising:
an electric heater adapted to generate heat when it is electrically powered, arranged so as to heat the water contained in the tray, in particular to evaporate it;
a positive temperature coefficient (PTC) adapted to be electrically powered, arranged inside the tray so as to be wetted by the water contained in the tray, adapted to operate as a sensor for the presence of water in the tray;
an electronic control unit connected to the electric heater and to the PTC cartridge, configured to control, in particular to allow or prevent, the electric power supply of the electric heater.

45. An evaporation tray according to claim 44, wherein the electronic control unit is configured to allow or prevent the electric power supply of the electric heater as a function of the electric power absorbed by the PTC cartridge or of the electric current with which the PTC cartridge is powered or as a function of the resistance of the PTC cartridge.

46-57. (canceled)
